(19) United States
(12) Patent Application Publication
(10) Pub. No.: US 2022/0188650 A1
(43) Pub. Date: Jun. 16, 2022

(54) Device and Method for Configuring a Technical System

(71) Applicant: Siemens Industry Software Inc., Plano, TX (US)

(72) Inventors: Santosh Kumar SINGH, Pune (IN); Thomas MOELLER, Weilerswist (DE)

(21) Appl. No.: 17/549,089

(22) Filed: Dec. 13, 2021

(30) Foreign Application Priority Data
Dec. 14, 2020 (EP) 20213837

(51) Int. Cl. G06N 5/00; G06N 5/02

(52) U.S. Cl. CPC G06N 5/006; G06N 5/022; G06N 5/025

(57) ABSTRACT

Device and method for configuring a technical system are disclosed, wherein the method includes generating a configuration model from configuration criteria for the technical system and the configuration model represents the technical system as an information model, where generating the configuration model includes validating the configuration criteria based on constraints associated with the technical system and identifying a maximum satisfiable rule set for the validated configuration criteria, the maximum satisfiable rule set being identified by determining a minimum number of conflicting rules to be removed to resolve conflicts with the validated configuration criteria, where the minimum number of conflicting rules being determined for rules ranked below the threshold severity; and by removing at least one of the minimum number of conflicting rules to generate the maximum satisfiable rule set.

### BACKGROUND OF THE INVENTION

### 1. Field of the Invention

The invention relates to a mobile data processing device, in particular a smartphone or a tablet, a computer program product and a method, for commissioning a sensor and an associated measuring transducer.

### 2. Description of the Related Art

Typically, a configuration model is an information model of a technical system. In the configuration model, the technical system may be depicted to adhere to certain constraints or rules. Defining the rules that control the set of values a user can choose from in order to configure a valid product plays a key role when setting up a configuration model for the technical system. Often a variety of rule types are supported by configuration devices/solvers. The variety of rule types define the relationship between the elements of the configuration model, e.g., dependency or incompatibility rules between two configuration settings.

With the ever-growing number of configuration features in the configuration models of a technical system, it is necessary to define suitable default rules to design a user-friendly configuration solver. The intent of a default rule is to try for a good prediction of the user's choices of configuration options without limiting the flexibility to select from the full range of variability of the features of the technical system.

The more default rules a configuration solver has the easier it is for a user to setup a technical system configuration that is ready to validate, test, manufacture, or purchase. The quality of the user experience depends to a large degree on the ability of these default rules to successfully predict the user's preferences. Therefore, many product configuration models define default rules for most if not all configuration options. In many cases, the assumed user preference for a given configuration option depends on selections made for other configuration options. It is therefore very common that multiple default rules derive different values for the same configuration option depending on the user's choices for other configuration options.

There are usually many conditions at which one or more default rules conflict with each other, one or more constraint rules, and/or one or more user selections. For example, when configuring a computer keyboard one default rule might select the keyboard layout (e.g., QWERTY vs QWERTZ) based on the shipping address. While another default rule evaluates the billing address to suggest the keyboard layout. If the billing and shipping addresses differ, then the two default rules conflict with each other.

Often there are multiple conflicting rules that need to be resolved to generate the configuration model. Conventional approaches to solve configuration models with default rules include sequential processing and formal default logic. These conventional approaches have shortcomings as identified below.

In sequential processing, the behavior of a default rule is defined by the combination of a) default rule formula and b) its relative position in a static sequence. This creates several secondary problems such as setting up a default rule, which is more difficult because the author needs to also keep its placement in view. The formula of a default rule and its relative position cannot be changed independently. With a growing number of default rules, it is increasingly difficult to assess the exact behavior of a given Default Rule. An enormous amount of analysis and testing is often required. A single static sequence usually does not allow every default rule to achieve its best effect for every configuration criterion. Further, the large number of default rules and the complexity of their preconditions makes it is increasingly difficult to find one static sequence that can handle all scenarios in a one-pass sequence. In many cases, the “one-pass” sequence does not exist. It is therefore common practice to keep looping over all default rules multiple times, which results in poor response times.

Formal default logic is a non-monotonic logic and defines a Default Assumption to comprise of 3 elements: a pre-condition, one or more justification conditions, and a conclusion condition. This creates two problems: first formal default logic is not supported in declarative constraint/configuration solvers. Second, an algorithm implementing the formal default logic is often super-exponentially scaled. Evaluating all “default extensions” has factorial scalability and is therefore very quickly unusable.

### SUMMARY OF THE INVENTION

In view of the foregoing, it is therefore and object of the invention to provide devices and methods for generating a configuration model that can benefit from improvements, in particular the configuration devices/solvers may benefit from higher reliability with lower computational effort.

This and other objects and advantages are achieved in accordance with the invention by a method of configuring a technical system, wherein the method comprises generating a configuration model for the technical system from configuration criteria for the technical system, the configuration model representing the technical system as an information model, where generating the configuration model comprises (i) validating the configuration criteria based on constraints associated with the technical system, the configuration criteria being valid when none of the constraints, having a severity level greater than or equal to a threshold severity, are violated and (ii) identifying a maximum satisfiable rule set for the validated configuration criteria, the maximum satisfiable rule set being either empty or comprises constraint rules and/or default rules, and where the maximum satisfiable rule set is identified by (i) determining a minimum number of conflicting rules to be removed to resolve conflicts with the validated configuration criteria, the minimum number of conflicting rules being determined for rules ranked below the threshold severity and (ii) removing at least one the minimum number of conflicting rules to generate the maximum satisfiable rule set.

It is also an object of the invention to provide a device for configuring a technical system that comprises a processor, a memory communicatively coupled to the processor, the memory comprising a configuration generation module configured to generate a configuration model of the technical system, where the configuration model represents the technical system as an information model comprising constraints arrangeable based on the severity level in accordance with the method in accordance with the invention.

It is also an object of the invention to provide a non-transitory computer-readable medium encoded with executable instructions (such as a software component on a storage device) that when executed, causes at least one processor to perform the method in accordance with the invention.

The present invention advantageously addresses the ever-increasing pressure to offer greater choice and variety in technical systems/products to meet end user expectations. The device in accordance with the present invention enables manufacturers to specialize a product/technical system to the specific needs of their customer. The configure-to-order approach, which brings product specialization closer to the customer, is managed with reliability, unlike conventional processes in which configure to-order can overwhelm resources with duplicated data that can introduce errors into product development. The present invention advantageously provides a method that delivers variant management that ensures (makes certain) conflicts in the configuration criteria are resolved reliably and consistently.

As used herein “technical system” refers to a product that is configured using a configuration solver or a configuration device or a configuration software implemented on a computing device. For example, the technical systems or products may be automobiles, a drilling machines, shoes, beverages, computing devices, and/or keyboards. The present invention is not limited by the aforementioned examples. In an exemplary embodiment, the technical system is represented as an information model using the configuration model, where the technical system is configured to comprise constraints arrangeable based on the severity level. The technical system is often engineered using the configuration devices based on the constraints. The engineering complexity may drastically increase as the technical systems become more complex, product cycle times become shorter, markets and manufacturing go global and customers demand more choices and customization. The present invention provides a reliable method to resolve conflicts while configuring the technical system.

As used herein “configuration model” refers to an information model that represents a physical technical system in a digital form. For example, the configuration model includes a definition of each feature of the technical system as datapoints that may be cross referenced to build the configuration model. In an embodiment, the technical system may be represented as constraints. As used herein “constraints” refer to the boundary conditions that are associated with the technical system. For example, in the case of a keyboard, the constraint may include layout of the keyboard based on the language of the user. In another example, permitted emission norms act like constraints to configuration of an automobile.

As used herein “configuration criteria” refers to a criterion that may be input by a user. The configuration criteria may also be derived from preference/customization requests provided by a user. The configuration criteria are validated/checked whether any constraints of the technical system are violated. If yes, then the configuration criteria are validated by performing a check to determine whether the violation is with regard to a constraint having a severity level greater than a threshold severity. As used herein “threshold severity” refers to a user definable threshold severity. Accordingly, a user defines whether configuration criteria are valid by setting the threshold severity.

The method for configuring the technical system includes generating the configuration model. Accordingly, the physical technical system can be configured and tested using an information model. The configuration model is generated from the configuration criteria after it is validated and when a maximum satisfiable rule set is identified.

The method accordingly includes validating the configuration criteria based on constraints associated with the technical system, where the configuration criteria are valid when none of the constraints, having a severity level greater than or equal to a threshold severity, are violated.

In an embodiment, the configuration criteria are checked for satisfiability against all the constraint(s) in an input constraint list which have a severity level equal to or greater than the threshold severity. In an example, the validity check may result one of the three outcomes, i.e., Satisfied, Unsatisfied and Unknown. The presently disclosed embodiments of the invention address the result when the validity check is satisfied. Accordingly, the disclosed embodiments of the invention are directed towards conflicts in constraints having severity lower than the threshold severity. By validating the configuration criteria, the disclosed embodiments of the invention streamline the effort in identifying conflicts and are directed to customer preferences that do not conflict with any constraint having a severity level that is equal to or greater than the threshold severity level.

The disclosed embodiments of the method in accordance with the invention also include identifying a maximum satisfiable rule set for the validated configuration criteria, where the maximum satisfiable rule set is either empty or comprises constraint rules and/or default rules. The disclosed embodiments of the present invention advantageously identify the maximum satisfiable rule set for the generation of the configuration model. Therefore, this ensures that only a minimum number of rules that most definitely cannot be satisfied are removed from the rule set during conflict resolution. The technical effect achieved is reliability and consistency in identifying the maximum satisfiable rule set. The disclosed embodiments of the invention ensure that, for the same configuration criteria input by two different users for the same technical system, the same maximum satisfiable rule set is achieved. Particularly, the disclosed embodiments of the invention allow reliability and consistency to be achieved without being dependent on conflict analysis capabilities in the underlying configuration/constraint solver. These capabilities are known to be computationally expensive and their specific results typically depend on a random seeding. Thereby, advantageously reducing the computation costs.

Further, the maximum satisfiable rule set is needed to infer choices for options that are not provided in a (user) input. The technical effect achieved is to the ability to derive complete and unique configuration criteria for all or as many different (user) inputs as possible. The more rules that are retained (and still be “valid”), then the higher the likelihood that a complete and unique configuration criterion can be achieved.

To identify the maximum satisfiable rule set, the disclosed embodiments of the method in accordance with the invention include determining a minimum number of conflicting rules to be removed to resolve conflicts with the validated configuration criteria, where the minimum number of conflicting rules are determined for rules ranked below the threshold severity, and at least one of the minimum numbers of conflicting rules is removed to generate the maximum satisfiable rule set.

In an embodiment, a set of rules are associable to the validated configuration criteria, where each of the set of rules are assigned a severity level and a sequence number and where the severity level and the sequence number define a ranking level for each of the rules. In accordance with disclosed embodiments of the invention, constraints with a severity level below the threshold severity are ranked based on the ranking level. For example, the conflict resolution may be executed separately for each ranking level or across the ranking levels. In another embodiment, the method may include associating each rule in the set of rules with the ranking level, where the ranking level of a specific rule is higher when the severity level is higher and where the ranking level of the specific rule is based on the sequence number when the severity level is the same. Using the ranking levels, the disclosed embodiments of the invention advantageously reduce rule complexity and maintenance effort. Further, the ranking levels increase the testability of the set of rules and thereby the maximum satisfiable rule set and in consequence the configuration model of the technical system. In addition, the ranking levels enable scalability when new rules or updates to the existing set of rules are performed.

In another embodiment, the method may include identifying unwanted rules from the set of rules. The unwanted rules can either be inactive, redundant, overruled, unjustified or inconsistent constraints. Further, the method may include removing rules in the set of rules when categorized based on a predefined category, where the predefined rule type comprises at least one of inconsistent, inactive, redundant, overruled and unjustified.

In a further embodiment, the method may include identifying conflicts in rules within each of the ranking level and across the ranking levels, determining the minimum number of conflicting rules as rules with lowest ranking level when conflicts across the ranking levels are identified, and removing at least one the minimum number of conflicting rules. The disclosed embodiments of the present invention identify conflicts that are both within a specific ranking level and across the ranking levels. By separating the rules into ranking levels, different methods for identifying the minimum number of conflicting rules can be removed. For example, when there is conflict across the ranking levels, the minimum number of conflicting rules in the lowest ranking level is one and the same is removed. However, if there are more than one conflicting rules in the lowest ranking level, then the disclosed embodiments of the invention advantageously identify which of the one or more conflicting rules to remove to generate the maximum satisfiable rule set.

Further, by identifying conflicting rules within the specific ranking level, the disclosed embodiments of the invention provide for a scenario in which the ranking levels may not be defined. Alternatively, same ranking levels may be defined to one or more rules in the set of rules. The disclosed embodiments of the invention provide a method for identifying conflicts within a specific ranking level. consequently, a user may not need to spend any effort in defining ranking levels, severity levels or sequence numbers.

In an embodiment, the method includes determining the conflicting rules based on the minimum number of the conflicting rules (n) to remove from within the specific ranking level to resolve all conflicts within the specific ranking level and/or ranking levels higher than the specific ranking level, determining one or more combinations of the conflicting rules within the specific ranking level, wherein each of the one or more combinations include the minimum number of conflicting rules (n), where removal of each of the combinations results in resolution of all the conflicts, and identifying a combination of the combinations to be removed using a chain representation of the one or more combinations, where the (one) combination to be removed is identified as end points of the chain representation.

The method may accordingly also include generating the chain representation of the combinations to determine the (one) combination that is to be removed. Generating the chain representation may depend on the assumption that the default rules are “Normal Default Rule”. The skilled person will appreciate that a default rule is considered as a “Normal Default Rule” when it has only one justification expression and the justification expression is the same as the conclusion expression. The disclosed embodiments of the invention intelligently arrange the combination of the conflicting rules to consistently identify the one combination that needs to be removed. Identifying consistently which of the multiple conflicting rules to remove is important considering a technical system typically has a large number of constraints and the configuration criteria when validated may still result in several conflicting rules.

In an embodiment, the minimum number of conflicting rules to remove from within the specific ranking level is referred to as cardinality. Accordingly, the disclosed embodiments of the invention may include determining a cardinality of conflicting rules within the specific ranking level, where the cardinality specifies the number of independent conflicts in the rules within the specific ranking level and wherein the minimum number of the conflicting rules that must be removed is the cardinality. Consequently, the disclosed embodiments of the invention determine the cardinality “X” by determining the minimum number of conflicting rules that need to be dropped for the validated configuration criteria to be conflict free or to become satisfiable. In an example, the determination of cardinality may be implemented as a cardinality constraint that is constructed based on pseudo-Boolean functions and is satisfied only when the validated configuration criteria violate no more than X constraints. For example, the cardinality X constraint can be used in a binary search algorithm, which allows for an efficient way to identify the minimum number of conflicting rules to remove to make validated configuration criteria conflict free.

In an embodiment of the present invention, the rules with highest ranking level below the threshold severity is processed first. If the rules in the ranking level conflict with the rule above the ranking level, then the conflicting constraints are removed, and remaining constraints are promoted to the high severity constraint list. Otherwise, all constraints in the current constraint set are promoted to the high severity constraint list. The rules with the next lower ranking level are then processed. Consequently, the disclosed embodiments of the invention iteratively ensures that the validated configuration criteria are conflict free.

In another embodiment, the method may include identifying a next threshold ranking based on an interval search, where the next threshold ranking is identified as a highest-ranking level below a current threshold ranking at which a conflict is identified, where the minimum number of conflicting rules are determined for the current threshold ranking and where ranking levels above the current threshold ranking are free of conflicts. As indicated above, the disclosed embodiments of the invention iteratively identify conflicts within the rules associated with the validated configuration criteria and resolve these conflicts systematically. The systematic conflict resolution enables a user to track the manner in which the disclosed embodiments of the invention have resolved the conflicting rules and thereby making the method consistent and reliable. In addition, this enables the method to be applied incrementally to leverage results of previous operations.

In an embodiment, there may be new rules or updates to the set of rules associated with the validated configuration criteria. In another embodiment, the method manages/adapts to the new rules or updates by determining the ranking level for the updated set of rules and by identifying the maximum satisfiable rule set for valid configuration criteria associated with the updated set of rules based on the steps discussed herein above.

The disclosed embodiments of the invention provide a method and device for identifying rules that conflict with the configuration criteria that may be input by a customer. Further, the disclosed embodiments of the invention provide a methodology for deciding, consistently and repetitively, which of the conflicting rules to drop in order to resolve all conflicts identified. Further, the disclosed embodiments of the invention optimize the number of conflicting rules to be dropped by narrowing it to the minimum number of conflicting rules that need to be dropped. The disclosed embodiments of the invention minimize the effort to maintain the ranking and also minimize the effort to maintain and test the impact of rule updates. Furthermore, the disclosed embodiments of the invention achieve the aforementioned advantages without evaluating all “default extensions” in an algorithm that has factorial scalability. In addition, the ranking levels make the disclosed embodiments of the invention easy to implement, scale and test.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the scope of the disclosure in its broadest form.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Below, the invention is described using the embodiments illustrated in the figures, in which:

FIG. 1 illustrates a method of configuring a technical system in accordance with an embodiment of the present invention;

FIGS. 2A-2D illustrate a method of evaluating ranking of a set of rules in accordance with an embodiment of the present invention;

FIG. 3 illustrates a chain representation for identifying a combination of conflicting rules to be removed in accordance with an embodiment of the present invention; and

FIG. 4 illustrates a device for configuring a technical system in accordance with an embodiment of the present invention.

### DETAILED DESCRIPTION OF THE EXEMPLARY EMBODIMENT

Hereinafter, embodiments for carrying out the present invention are described in detail. The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

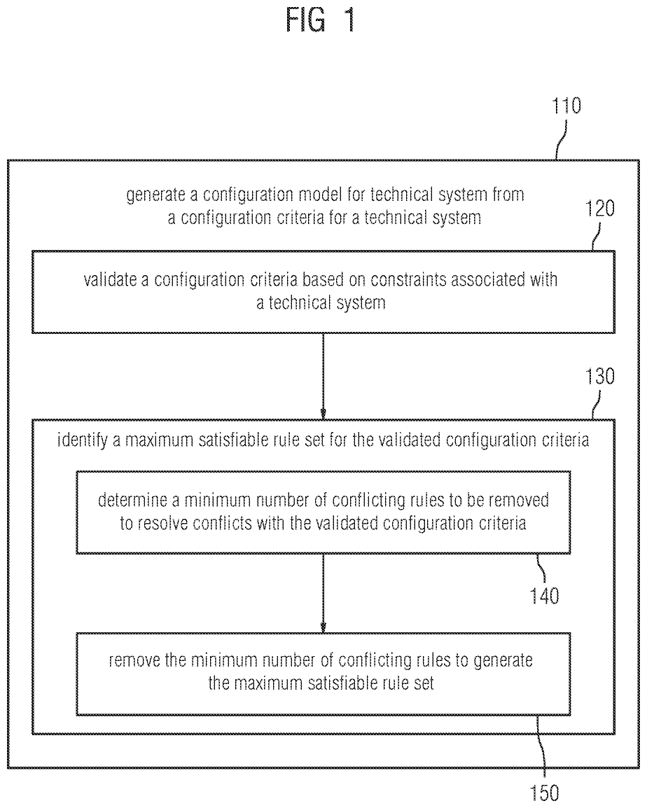

FIG. 1 illustrates a method of configuring a technical system in accordance with an embodiment of the present invention. The method for configuring the technical system starts at step 110 by generating a configuration model for the technical system from configuration criteria. In an embodiment, step 110 may include receiving the configuration criteria input by a user. The step 110 includes multiple intermediate steps 120 and 130.

At step 120 the configuration criteria are validated based on constraints associated with the technical system. At step 120 the configuration criteria are checked to determine whether the constraints, having a severity level greater than or equal to a threshold severity, are violated. Accordingly, the configuration criteria are validated only when none of the constraints have a severity level greater than or equal to a threshold severity level. The validated configuration criteria may be associated with a set of rules are associable. Each rule in the set of rules is assigned the severity level and a sequence number. The severity level and the sequence number define a ranking level for each of the rules. In an embodiment, at step 120 each rule in the set of rules is associated with the ranking level. The ranking level of a specific rule is higher when the severity level is higher. If the severity level is the same, then the ranking level depends on the sequence number.

In an embodiment, the validation can result in three outcomes, i.e., Satisfied, Unsatisfied and Unknown. When the outcome is Satisfied, the input expression is satisfiable and execution control can advance to next step of processing to deal with conflicts in rules below the threshold severity. When the outcome is Unsatisfied, the input configuration criteria is determined as unsatisfiable. The configuration solver implementing the method notifies the user/customer the Unsatisfied outcome along with reason for the unsatisfied verdict. When the outcome is Unknown, a user is notified that the following scenarios have resulted in the Unknown outcome:
a. Non-linear integer arithmetic b. Quantifiers, e.g. “for each” (∀), or “there exists some” (∃) The method step 110 proceeds from step 120 to 130 only when the outcome is Satisfied.

At step 130 a maximum satisfiable rule set for the validated configuration criteria is identified. The maximum satisfiable rule set can be empty or may include constraint rules and/or default rules. In an embodiment, the maximum satisfiable rule set is identified by removing unwanted constraints with a predefined category such as Inactive, Redundant, Overruled and Unjustified.

Inactive Rule Category

Inactive rules are processed by processing the applicability condition of a rule. If the majority of default rules have an applicability condition that combine values of the same family a significant performance gain is achieved by splitting all applicability conditions into their respective implicant expressions. It is a common practice that default rules combine one or more product model expression, e.g., “Model=Coupe OR Model=Sport or Model=Sedan”. In this way, hundreds of different Default Rules may use a small amount of unique implicant expressions. Each implicant expression is tested for satisfiability against rules above the threshold severity.

1. Inactive Rule Category:

The constraint is declared Inactive if all its implicant expressions are Unsatisfiable. Consider the below example:

Models: M1, M2, M3, M4

A: A1, A2, A3, A4

B: B1, B2, B3, B4

Rules:

A1 is available to M1, M2

B1 is available to M1, M2

Default Rule:

D1: M1|M2 defaults A1

D2: M3|M4 defaults B4

In the above example, default rule D2 is detected as inactive because the implicants of its applicability condition, M3 as well as M4 are Unsatisfiable against the rule set: B4 is neither available to M3 nor M4.

2. Redundant Rule Category

This category of rules identifies the rules within the threshold severity that try to assert a Boolean expression which is already asserted by the other high severity constraints. For example, consider the following:

Models: M1, M2, M3, M4

A: A1, A2, A3, A4

B: B1, B2, B3, B4

Rules:

A1 is available to M1, M2

B1 is available to M1, M2

Include rule:

R1: M1|M2 includes A1 & B1

Default Rule:

D1: M1|M2 defaults A1

D2: M3|M4 defaults B4

In the above example, D1 is a redundant rule in presence of rule R1. Assuming that a rule has the form “A→B”, the expression A&˜B is tested for satisfiability to check redundancy of the rule where A is applicability and B is the subject of the rule.

3. Overruled Rule Category

This category identifies rules whose subject is overruled by rules having severity level greater than and equal to the threshold severity level. Consider the below data scenario:

Models: M1, M2, M3, M4

A: A1, A2, A3, A4

B: B1, B2, B3, B4

Rules:

A1 is available to M1, M2

A2 is available to M1, M2

B1 is available to M1, M2

B2 is available to M1, M2

Include rule:

R1: M1|M2 includes A1 & B1

Default Rule:

D1: M1|M2 defaults A2

D2: M3|M4 defaults B2

In the above example, high severity R1 rule overrules the default rule D1 and D2. To check for satisfiability, (˜A|B) expression is tested for satisfiability.

4. Unjustified Rule Category

Rules in this category are denied by rules having severity level greater or equal to the threshold severity level. The expression that is checked for testing whether a constraint is Unjustified is (A & B), where “A” is applicability and “B” is subject. Depending on how the user continues with the refinement of the technical system (product) configuration criteria Unjustified default constraints either become Overruled (if the user continues with selecting A), or Redundant (if the user continues with selecting Not(A)).

In an embodiment, step 130 is performed when the rule with the highest-ranking level (below the threshold severity) has a conflict. At step 130, the highest-ranking level is identified using a partition search. A partition search is an operation for finding the conflicting rules in the set of rules that are ranked from the highest-ranking level to the lowest ranking level. Once ranked set of rules are divided into halves, the rules in the first half are checked for conflicts. If no conflict is found, then the second half is evaluated for conflicts.

Step 130 includes intermediate steps 140 and 150. At step 140, a minimum number of conflicting rules to be removed are determined to resolve conflicts with the validated configuration criteria. At step 150, the minimum number of conflicting rules are removed to generate the maximum satisfiable rule set.

In an embodiment, step 130 includes identifying conflicts in rules within each of the ranking level and across the ranking levels. If the conflicts are identified across the ranking levels, then step 130 includes determining the minimum number of conflicting rules as rules with lowest ranking level when conflicts across the ranking levels are identified; and removing the minimum number of conflicting rules.

In another embodiment, step 130 address a scenario in which where there are no ranking levels assigned or all the conflicts are within a specific ranking level.

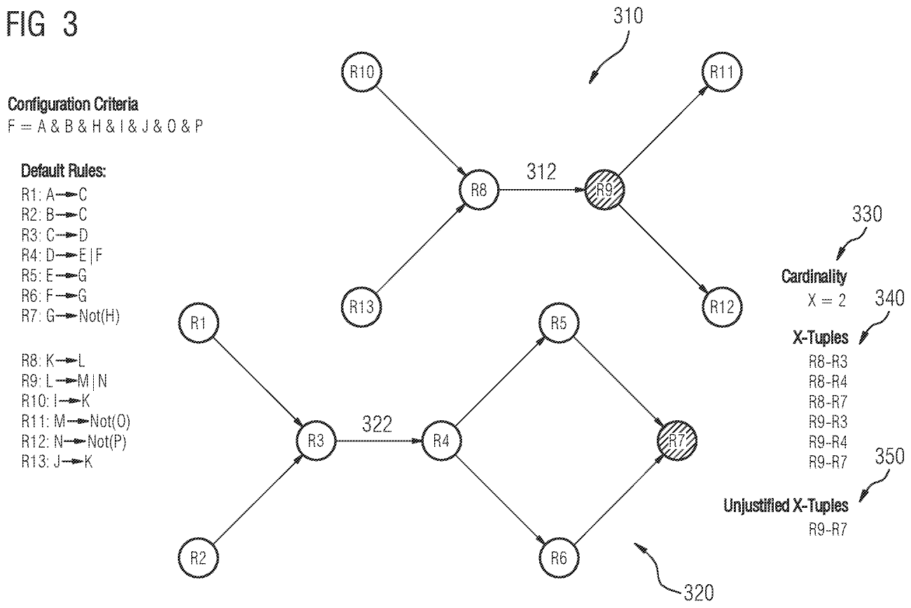

Accordingly, step 130 may include determining the conflicting rules based on the minimum number of the conflicting rules. The identified conflicting rules would resolve all conflicts within the specific ranking level and/or ranking levels higher than the specific ranking level, if removed. Step 130 may include determining one or more combinations of the conflicting rules within the specific ranking level. Each of the one or more combinations include the minimum number of conflicting rules (n), where removal of each of the combinations results in resolution of all the conflicts. For example, if the minimum number of conflicting rules are determined as 2, then the combination with 2 conflicting rules is determined. Each of those combinations resolve conflicts, if removed. Step 130 identifies which of the multiple combinations to remove by using a chain representation of the one or more combinations. The combination to be removed is identified as end points of the chain representation. A detailed description of the chain representation is provided hereinafter in FIG. 3.

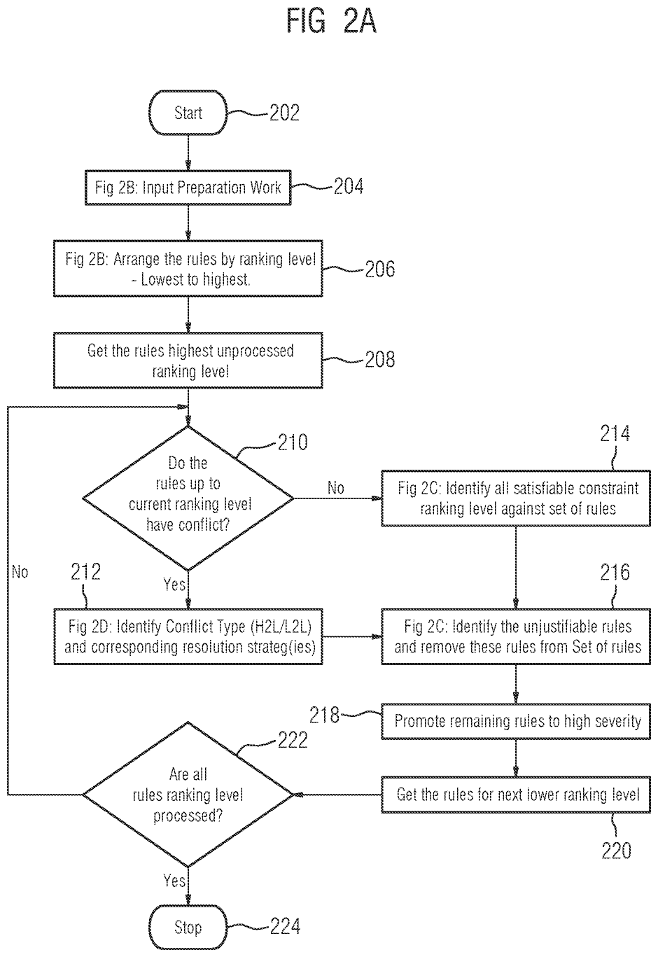

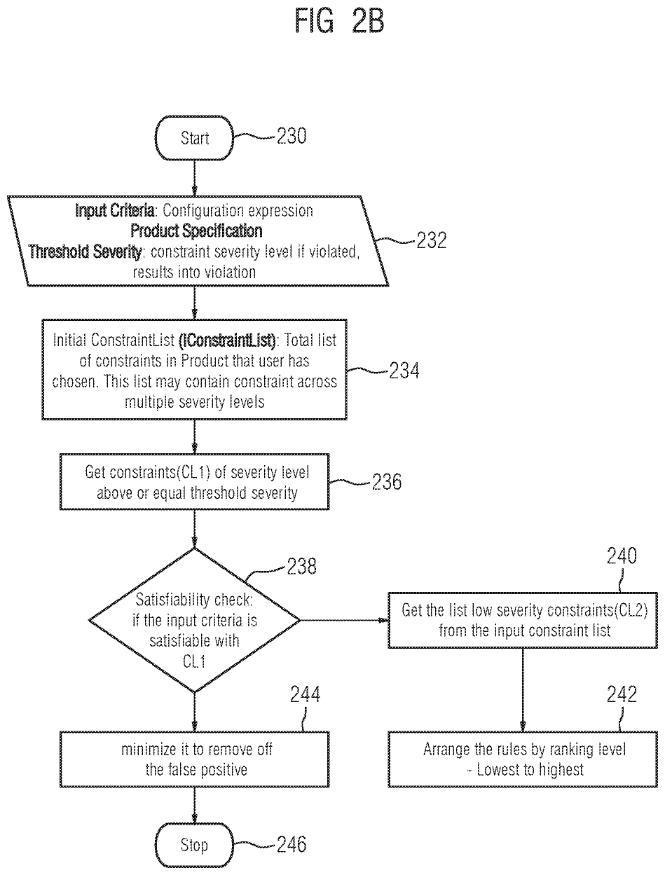

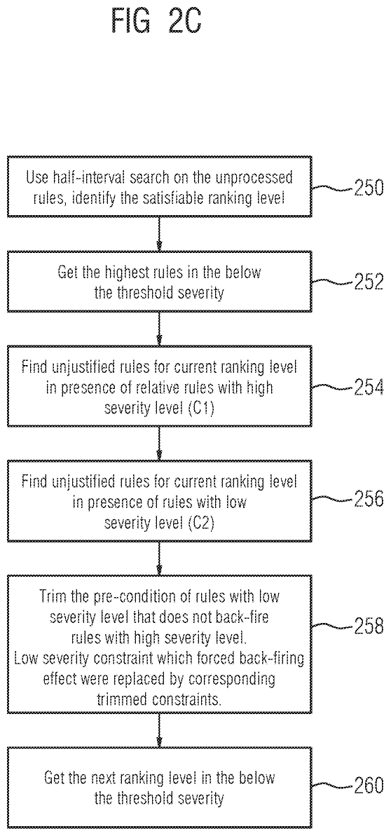

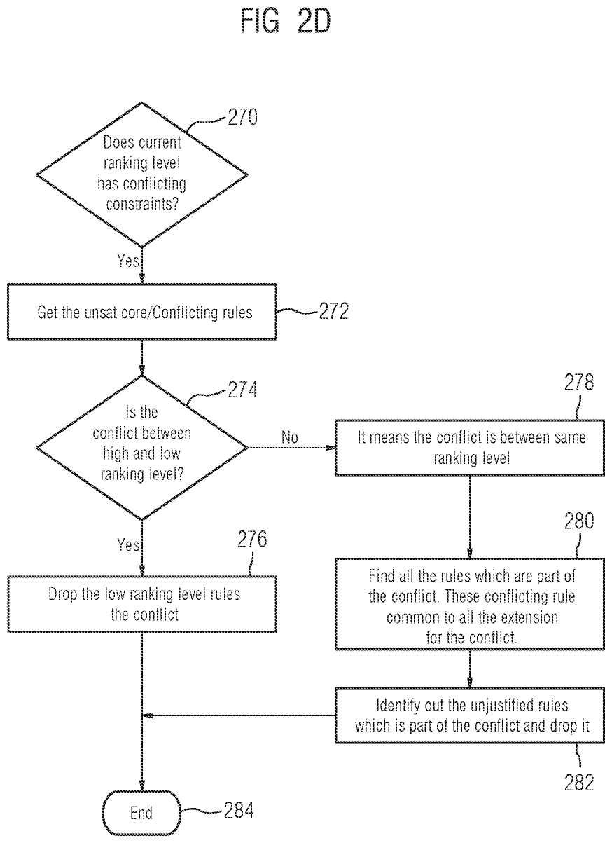

FIGS. 2A-2D illustrate a method of evaluating ranking of a set of rules and generating the maximum satisfiable rule set in accordance with an embodiment of the present invention. The maximum satisfiable rule set is used to generate a configuration model, which is in turn used to configure a product. The method is broken down into sub-methods as illustrated in the flowcharts 2A, 2B, 2C and 2D.

As illustrated, the method is captured in flowchart 2A which cross references flowcharts 2B, 2C and 2D. The method starts at steps 202 with the initialization of the constraint solver module in a device. At step 204, the flowchart 2B is referenced to obtain the preparation work. Further at step 206, the flowchart 2B is referenced to get an arranged set of rules associated with configuration criteria of a product.

Reference is made to flowchart 2B to explain steps 204 and 206. As such, flowchart 2B begins with step 230 with the initialization of the preparation module. At step 232, configuration criteria are/is received or determined. In an embodiment, the configuration criteria are/is a configuration expression input by a user/customer. Further, at step 232, the product specification of the product. Furthermore, a threshold severity level is obtained from the user.

At step 234, the configuration criteria are/is validated based on the list of constraints in the product. The list of constraints may be associated with multiple severity levels. In other words, the constraint list may contain constraints across multiple severity levels. At step 236, the constrains (CL1) with a severity level above or equal to the threshold severity level are retrieved. At step 238, a satisfiability check is performed for the input criteria (i.e., the configuration criteria) and the constraints (CL1) with severity level greater or equal to the threshold severity.

If the configuration criteria does/do not violate the constraints (CL1) with a severity level greater or equal to the threshold severity level, then step 240 is performed. At step 240, the constraints below the threshold severity level are obtained from the constraint list of the product. The constraints below the threshold severity level are associated with a set of rules including either constraint rules or default rules. At step 242, the rules in the set of rules are arranged by a ranking level. The ranking level is a combination of the severity level and a sequence number associated with the rules.

If the configuration criteria violate(s) the constraints (CL1) with a severity level greater or equal to the threshold severity level, then step 244 is performed. At step 244, the configuration criteria and the constraints are analyzed and the violation is explained to the user.

Referring back to flowchart 2A, after step 206, the configuration criteria is validated and the rules are arranged in accordance with the ranking level. At step 208, the rules with highest unprocessed ranking level, below the threshold severity level, are obtained. At step 210, a check is performed to determine whether the rules up to the highest unprocessed ranking level have conflicts. As used herein “unprocessed” refers to whether a check for a conflict has already been conducted or not.

If there are no conflicts in the rules up to the highest unprocessed ranking level, then step 214 is performed. At step 214 and 216, flowchart 2C is referenced. At step 214, the rules that are satisfied/satisfiable are identified in the set of rules. At step 216, the unsatisfiable rules are identified and removed from the set of rules. At step 218, the rules remaining in the set of rules are promoted to high severity level, i.e., above the threshold severity level.

Steps 214 and 216 can be further detailed by referring to flowchart 2C. Here, flowchart 2C begins at step 250 by using a half interval search on the unprocessed rules to identify the satisfiable rules and the ranking levels with no conflict. Accordingly, step 250 identifies the ranking level at which a conflict is determined (conflict level). At step 252, the highest ranked rules (i.e., rules with the highest-ranking level) below the threshold severity level are obtained.

At step 254, the rules in (relatively) high severity level/ranking level are identified if they are unjustified in view of the rules in the current ranking level. At step 256, check is performed to determine whether rules exist rules between (between level) the current ranking level and the conflict level, because of which a rule in the current ranking level becomes unjustified. At step 258, pre-conditions of rules in the “between level” (intermediate level) are trimmed such that they do not cause any rule to become unjustified. Further, the rules in the intermediate level are replaced by the trimmed rules. At step 260, the next ranking level is analyzed to identify the unjustified rules. The iterative nature of the present invention ensures that conflicts are thoroughly identified.

Referring again to flowchart 2A, the method also provides a solution when conflicts are identified within a ranking level or across ranking levels. The flowchart 2D is referenced to identify and resolve such conflicts.

Thus, flowchart 2D starts at step 270 with the determination of whether ranking levels below the threshold severity level has conflicting rules. At step 272, the conflicting rules are retrieved. At step 274, a determination of whether the conflict is in rules between high and low ranking levels, i.e., across one or more ranking levels. If yes, then step 276 is performed to drop the rules in the low-ranking level to resolve the conflicts. If no, then the conflict is within the ranking level and the same is identified at step 278. Further, at step 278, a cardinality for the conflicting rules is determined. Furthermore, based on the cardinality (X) one or more combinations (i.e., X-tuples) are identified, where removal of any one of the combinations resolves conflicts.

At step 280, all the rules that form part of the conflict are identified. Additionally, the conflicting rules common to all extensions of the conflict (as shown in FIG. 3 arrow 312 and 322) are identified. At step 282, the unjustified rules among the conflicting rules are identified and removed. The method of identifying which conflicting rules to remove from within the specific ranking level is explained in FIG. 3. Further, step 282 includes removing rules in the set of rules when categorized as one of inactive, redundant, overruled and unjustified.

At the end of flowchart 2D, the conflicting rules are removed and a satisfiable rule set can be augmented with the remaining rules. At the last iteration, the satisfiable rule set becomes the maximum satisfiable rule set. Accordingly, flowchart 2D connects to flowchart 2C at step 254 (as shown in flowchart 2A). The skilled person will appreciate that the conflict level identified in step 250 is processed in flowchart 2D. Alternatively, the conflict level may be the highest unprocessed ranking level determined at step 210.

Returning to flowchart 2A, at step 220, the rules for the next lower ranking level (below the threshold severity) are identified. The rules for the next ranking level are checked for conflicts (i.e., processed). At step 222, a determination is made as to whether all the rules in the ranking levels are checked. If yes, the method ends at step 224 and the maximum satisfiable rule set is output. If no, the method is iteratively performed till all the rules in the ranking levels are processed.

FIG. 3 illustrates chain representations 310 and 320 for identifying a combination 350 of conflicting rules to be removed in accordance with an embodiment of the present invention.

The chain representations 310 and 320 are built when conflicts are identified in the default rules R1 to R13. The default rules are associated with the configuration criteria F.

As indicated, the configuration criteria F=A&B&H&I&J&O&P

Default Rules are as follows:

R1: A→C

R2: B→C

R3: C→D

R4: D→E|F

R5: E→G

R6: F→G

R7: G→Not(H)

R8: K→L

R9: L→MIN

R10: I→K

R11: M→Not(O)

R12: N→Not(P)

R13: J→K

The configuration criteria F is analyzed to determine that the cardinality 330 “X”=2 independent number of conflicts. The combination of the conflicts and the sequence are shown as disjunctive chain representations 310 and 320 of the default rules. Each chain representation 310 and 320 has 4 unique constraint paths. Each path represents a different minimal number of conflicting rules for the corresponding conflict. Constraints that are common to all minimal conflicting rules in a given chain representation 310, 310 are indicated by arrows 312 and 322, respectively.

A binary search using a “Cardinality X” constraint that searches for the cardinality 330 identifies a cardinality of X=2 for this scenario, because there are X=2 independent conflicts and each needs to be resolved by removing (at least) one violated constraint in each disjunctive chain for F to become satisfiable. This step scales with Log(n), where n is the size of the set of rules. During implementation, the response time of the binary search for the cardinality 330 can be improved based on heuristics. For example, if X is expected to be small compared to n, it seems advantageous to begin with a 90:10 interval search (probing for X=n/10), as opposed to blindly using a Half-Interval Search with 50:50 intervals (probing for X=n/2).

The cardinality 330 is used to enumerate all combinations 340 i.e., X-tuples (2-tuples here) of constraints for which the “Cardinality X” constraint is satisfiable. The first combination is a byproduct of the previous binary search. To find the next combination, an additional rule can be added that disallows the selection of the same X-tuple in the next check satisfiability determination with the “Cardinality X” constraint for X=2, until the configuration solver can no longer find a new solution that satisfies the “Cardinality X” constraint.

The next step determines which combination to filter out from the combinations 340. In an embodiment, a new rule set may be generated that contains all the conflicting rules that appear in any combination. These rules are then analyzed till no more justified rules are found. Accordingly, when there are no more justified rules in the new rule set, the remaining rules are unjustified. They form the one combination 350 to remove.

As used herein “justified” refers to an implication that the rules have an entailed precondition and a satisfiable THEN condition. Further, “unjustified” refers to an implication that a given rule has an unsatisfiable combination of precondition and justification condition. To generate the minimum satisfiable rule set, each of the rules in the minimum satisfiable rule set must be justifiable.

The example in FIG. 3 relates to a technical system. The configuration criteria F and the configuration features A-P relate to features of a given technical system. For example, the technical system is an automotive truck. The configuration features of the automotive truck are listed below.

| Configuration | |
|---|---|
| Option | Description |
| A | RESTRAINT PROVISIONS CHILD, REAR SEAT, REAR |
| | FACING |
| B | RESTRAINT SYSTEM SEAT, INFLATABLE, DRIVER & |
| | PASS, FRONT & SEAT SIDE |
| C | ROLLOVER BAR |
| D | ROADSIDE ASSISTANCE PACKAGE |
| E | DRIVER INFORMATION CENTER KIT |
| F | RADIO KIT, NAVIGATION |
| G | ENTERTAINMENT PKG REAR SEAT, SINGLE DISPLAY |
| H | ADDITIONAL DVD SCREEN |
| I | COOLING SYSTEM HEAVY DUTY |
| J | PROVISIONS SNOW PLOW PREP |
| K | PERFORMANCE PACKAGE HIGHER PAYLOAD |
| L | LEVEL CONTROL AUTO, AIR, HEAVY DUTY |
| M | TRAILER HITCH WEIGHT DISTRIBUTING PLATFORM |
| N | SWAY CONTROL HITCH |
| O | COVER TRAILER HITCH RECEIVER |
| P | LOCKING PIN, TRAILER HITCH |

With these definitions, the configuration formula “F=A&B&H&I&J&O&P” maps to:
Restraint Provisions Child, Rear Seat, Rear Facing AND Restraint System Seat, Inflatable, Driver & Pass, Front & Seat Side AND Additional Dvd Screen AND Cooling System Heavy Duty AND Provisions Snow Plow Prep AND Cover Trailer Hitch Receiver AND Locking Pin, Trailer Hitch

The Rules R1, R2, . . . , R12, R13 map to the following default Rules for the automotive truck:

Default Rule If Then Alternative

| | | | |
|---|---|---|---|
| R1 | Restraint provisions | Rollover bar | |
| | child, rear seat, rear | | |
| | facing | | |
| R2 | Restraint system seat, | Rollover bar | |
| | inflatable, driver & pass, | | |
| | front & seat side | | |
| R3 | Rollover bar | Roadside | |
| | | assistance | |
| | | package | |
| R4 | Roadside assistance | Driver information | RADIO KIT, |
| | package | center kit | NAVIGATION |
| R5 | Driver information center | Entertainment pkg | |
| | kit | rear seat, single | |
| | | display | |
| R6 | Radio kit, navigation | Entertainment pkg | |
| | | rear seat, single | |
| | | display | |
| R7 | Entertainment pkg rear | Not: additional | |
| | seat, single display | dvd screen | |
| R8 | Performance package | Level control auto, | |
| | higher payload | air, heavy duty | |
| R9 | Level control auto, air, | Trailer hitch | SWAY |
| | heavy duty | weight distributing | CONTROL |
| | | platform | HITCH |
| R10 | Cooling system heavy | Performance | |
| | duty | package higher | |
| | | payload | |
| R11 | Trailer hitch weight | Not: cover trailer | |
| | distributing platform | hitch receiver | |
| R12 | Sway control hitch | Not: locking pin, | |
| | | trailer hitch | |
| R13 | Provisions snow plow | Performance | |
| | prep | package higher | |
| | | payload | |

The method according to the present invention would consistently choose to drop R7 and R9 for the configuration criteria F.

Accordingly, the configuration model is generated from the maximum satisfiable rule set that includes rules associated with the following configuration features:
Restraint Provisions Child, Rear Seat, Rear Facing AND Restraint System Seat, Inflatable, Driver & Pass, Front & Seat Side AND Rollover Bar AND Roadside Assistance Package AND choice of: (driver information center kit) or (radio kit, navigation) AND Entertainment Package Rear Seat, Single Display AND Additional DVD Screen AND Cooling System Heavy Duty AND Provisions Snow Plow Prep AND Cover Trailer Hitch Receiver AND Locking Pin, Trailer Hitch AND Performance Package Higher Payload AND Level Control Auto, Air, Heavy Duty

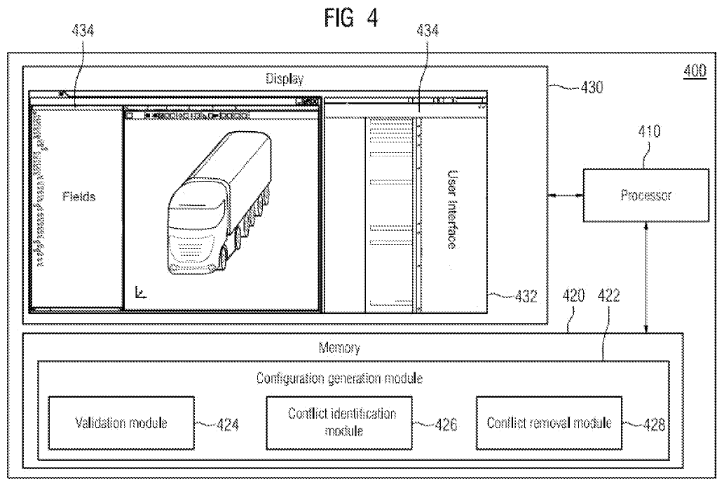

FIG. 4 illustrates a device 400 for configuring an automotive truck in accordance with an embodiment of the present invention. The skilled person would appreciate that the device 400 can be implemented in a distributed computing environment such as a cloud computing platform. Accordingly, the device 400 in implementation may be several computing devices orchestrated to perform functions of the device 400.

The device 400 is also referred to as a configuration solver or a constraint solver. The device 400 comprises a processor 410 communicatively coupled to a memory unit 420 and a display 430. The memory includes one or more modules 422-428 comprising computer implemented instructions. The display 430 renders a User Interface (Up/Graphical User Interface (GUI) 432. In a distributed computing environment, the processor 410 may be implemented on a remote server accessible via wired/wireless network. The memory unit 420 may be distributed with the modules 222-228 stored across multiple computing devices. Further, the display 430 may be part of a user computing device that may be a client server communicatively coupled to the remote server implementing the processor 410. The skilled person would further appreciate that the display 430 may be implemented on a device supporting augmented reality to enable gesture-based interaction with the UI 432.

In operation, configuration criteria are/is input or determined from a user input to the GUI 432. The processor 410 executes the instruction stored in the configuration generation module 422. On execution, the configuration generation module 422 is used to generate a configuration model for the automotive truck. The configuration model is illustrated on the GUI 432 with configuration features and constraints/rules illustrated in fields 434.

The configuration generation module 422 is configured to generate the configuration model by executing a validation module 424, a conflict identification module 426 and a conflict removal module 428. The validation module 424 is configured to validate the configuration criteria based on constraints associated with the automotive truck. For example, the constraints include rules indicated from R1-R13 in FIG. 3. The configuration criteria are valid when none of the constraints, having a severity level greater than or equal to a threshold severity, are violated. A set of rules are associable to the validated configuration criteria. Each of the set of rules are assigned the severity level and a sequence number, where the severity level and the sequence number define a ranking level for each of the rules.

After validating the configuration criteria, the conflict identification module 426 is configured to determine a minimum number of conflicting rules to be removed to resolve conflicts with the validated configuration criteria. The minimum number of conflicting rules are determined for rules ranked below the threshold severity level. In an embodiment, the conflict identification module 426 is configured to identify conflicts in rules within each of the ranking level and across the ranking levels. Further, in order to determine the minimum number of conflicting rules as rules with lowest ranking level when conflicts across the ranking levels are identified.

In an embodiment, the conflict identification module 426 identifies conflicts within a specific ranking level, the conflict identification module 426 is configured to determine the conflicting rules based on the minimum number of the conflicting rules (n) to remove from within a specific ranking level to resolve all conflicts within the specific ranking level and/or ranking levels higher than the specific ranking level. Further, the conflict identification module 426 determines one or more combinations of the conflicting rules within the specific ranking level. Each of the one or more combinations include the minimum number of conflicting rules (n) and wherein removal of each of the combinations results in resolution of all the conflicts. Furthermore, the conflict identification module 426 is configured to generate a chain representation (e.g., chain representations 310 or 320) for the one or more combinations of conflicting rules as indicated in FIG. 3.

The conflict removal module 428 is configured to remove the minimum number of conflicting rules to generate a maximum satisfiable rule set. In an embodiment, when the conflicts are identified across the ranking levels, the minimum number of conflicting rules as rules with lowest ranking level are removed. In another embodiment, when the conflicts are identified within the specified ranking level, the conflict removal module is configured to identify a combination (e.g., R7 and R9) of the combinations to be removed using the chain representation. The combination to be removed is identified as end points of the chain representation.

The skilled person in the art will appreciate that the automotive truck is merely an example of a technical system or product to be configured. The function and operation of the device 400 applies to all technical systems and products that have multiple configuration features.

For the purpose of this description, a computer-usable or computer-readable non-transitory storage medium can be any apparatus that can contain, store, communicate, propagate, or transport the program for use by or in connection with the instruction execution system, apparatus, or device. The medium can be electronic, magnetic, optical, electromagnetic, infrared, or semiconductor system (or apparatus or device) or a propagation mediums in and of themselves as signal carriers are not included in the definition of physical computer-readable medium include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and DVD. Both processing units and program code for implementing each aspect of the technology can be centralized or distributed (or a combination thereof) as known to those skilled in the art. Additionally, while the current disclosure describes the configuration tool 110 as an independent component, the configuration tool may be a software component and may be realized within a distributed control system or an engineering software suite. Additionally, in an embodiment, one or more parts of the engineering module may be realized within the technical system.

While the present disclosure has been described in detail with reference to certain embodiments, it should be appreciated that the present disclosure is not limited to those embodiments. In view of the present disclosure, many modifications and variations would be present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within their scope. All advantageous embodiments claimed in method claims may also be apply to system/device claims.

What is claimed is:

1. A method for configuring a technical system, comprising:
generating a configuration model for technical system, the configuration model being generated from configuration criteria for the technical system and the configuration model representing the technical system as an information model, said generating the configuration model comprising:
validating the configuration criteria based on constraints associated with the technical system, the configuration criteria being valid when none of the constraints, having a severity level greater than or equal to a threshold severity, are violated; and
identifying a maximum satisfiable rule set for the validated configuration criteria, the maximum satisfiable rule set being either empty or comprises at least one of constraint rules and default rules, and the maximum satisfiable rule set being identified by:
determining a minimum number of conflicting rules to be removed to resolve conflicts with the validated configuration criteria, the minimum number of conflicting rules being determined for rules ranked below the threshold severity; and
removing at least one of the minimum number of conflicting rules to generate the maximum satisfiable rule set.

2. The method according to claim 1, wherein a set of rules are associable to the validated configuration criteria; wherein each of the set of rules are assigned the severity level and a sequence number; and wherein the severity level and the sequence number define a ranking level for each of the rules.

3. The method according to one of claim 1, further comprising:
associating each rule in the set of rules with the ranking level;
wherein the ranking level of a specific rule is higher when the severity level is higher.

4. The method according to claim 2, further comprising:
associating each rule in the set of rules with the ranking level;
wherein the ranking level of a specific rule is higher when the severity level is higher.

5. The method according to one of claim 2, wherein the ranking level of the specific rule is based on the sequence number when the severity level is the same.

6. The method according to claim 3, wherein the ranking level of the specific rule is based on the sequence number when the severity level is the same.

7. The method according to claim 2, wherein at least one rule of the set of rules is assignable with the same ranking level.

8. The method according to claim 3, wherein at least one rule of the set of rules is assignable with the same ranking level.

9. The method according to claim 1, wherein identifying a maximum satisfiable rule set for the validated configuration criteria comprises:
identifying conflicts in rules within each of the ranking levels and across the ranking levels;
determining the minimum number of conflicting rules (330) as rules with lowest ranking level when conflicts across the ranking levels are identified; and
removing the minimum number of conflicting rules.

10. The method according to claim 1, further comprising:
determining the conflicting rules based on the minimum number of the conflicting rules to remove from within a specific ranking level to resolve all conflicts within at least one of the specific ranking level and the ranking levels higher than the specific ranking level;
determining at least one combination of the conflicting rules within the specific ranking level, each of the at least one combination including the minimum number of conflicting rules and removal of each of the combinations results in resolution of all the conflicts; and
identifying a combination of the combinations to be removed utilizing a chain representation of the at least one combination, the combination to be removed being identified as end points of the chain representation.

11. The method according to claim 7, further comprising:
determining the conflicting rules based on the minimum number of the conflicting rules to remove from within a specific ranking level to resolve all conflicts within at least one of the specific ranking level and the ranking levels higher than the specific ranking level;
determining at least one combination of the conflicting rules within the specific ranking level, each of the at least one combination including the minimum number of conflicting rules and removal of each of the combinations results in resolution of all the conflicts; and
identifying a combination of the combinations to be removed utilizing a chain representation of the at least one combination, the combination to be removed being identified as end points of the chain representation.

12. The method according to claim 1, wherein determining the minimum number of the conflicting rules to remove from within the specific ranking level comprises:
determining a cardinality of conflicting rules within the specific ranking level, the cardinality specifying a number of independent conflicts in the rules within the specific ranking level and the minimum number of the conflicting rules that must be removed being the cardinality.

13. The method according to claim 10, wherein determining the minimum number of the conflicting rules to remove from within the specific ranking level comprises:
determining a cardinality of conflicting rules within the specific ranking level, the cardinality specifying a number of independent conflicts in the rules within the specific ranking level and the minimum number of the conflicting rules that must be removed being the cardinality.

14. The method according to claim 1, further comprising:
identifying a next threshold ranking based on an interval search, the next threshold ranking being identified as a highest-ranking level below a current threshold ranking at which a conflict is identified;
wherein the minimum number of conflicting rules are determined for the current threshold ranking; and
wherein ranking levels above the current threshold ranking are free of conflicts.

15. The method according to claim 1, further comprising:
removing rules in the set of rules when categorized based on a predefined category comprising at least one of inactive, redundant, overruled and unjustified.

16. The method according to claim 1, further comprising:
adapting to updates in the set of rules by:
determining the ranking level for the updated set of rules; and
identifying the maximum satisfiable rule set for valid configuration criteria associated with the updated set of rules.

17. The method according to claim 1, wherein the technical system is represented as an information model using the configuration model; and wherein the technical system is configured to comprise constraints arrangeable based on the severity level.

18. A device for configuring a technical system, the device comprising:
a processor;
a memory communicatively coupled to the processor, the memory comprising a configuration generation module configured to generate a configuration model of the technical system, the configuration model representing the technical system as an information model comprising constraints arrangeable based on a severity level;
wherein the processor is configured to:
generate the configuration model for technical system, the configuration model being generated from configuration criteria for the technical system, said generating the configuration model comprising:
validating the configuration criteria based on constraints associated with the technical system, the configuration criteria being valid when none of the constraints, having a severity level greater than or equal to a threshold severity, are violated; and
identifying a maximum satisfiable rule set for the validated configuration criteria, the maximum satisfiable rule set being either empty or comprises at least one of constraint rules and default rules, and the maximum satisfiable rule set being identified by:
determining a minimum number of conflicting rules to be removed to resolve conflicts with the validated configuration criteria, the minimum number of conflicting rules being determined for rules ranked below the threshold severity; and
removing at least one of the minimum number of conflicting rules to generate the maximum satisfiable rule set.

19. A non-transitory computer readable medium encoded with machine-readable program instructions which, when executed by at least one processor, cause at least one server to configuring a technical system, the program comprising:
program code for generating a configuration model for technical system, the configuration model being generated from configuration criteria for the technical system and the configuration model representing the technical system as an information model, said generating the configuration model comprising:
program code for validating the configuration criteria based on constraints associated with the technical system, the configuration criteria being valid when none of the constraints, having a severity level greater than or equal to a threshold severity, are violated; and
program code for identifying a maximum satisfiable rule set for the validated configuration criteria, the maximum satisfiable rule set being either empty or comprises at least one of constraint rules and default rules, and the maximum satisfiable rule set being identified by:
determining a minimum number of conflicting rules (330) to be removed to resolve conflicts with the validated configuration criteria, the minimum number of conflicting rules being determined for rules ranked below the threshold severity; and
removing at least one of the minimum number of conflicting rules to generate the maximum satisfiable rule set.
